(19) United States
(12) Patent Application Publication
(10) Pub. No.: US 2002/0095422 A1
(43) Pub. Date: Jul. 18, 2002

(54) Method for creating a balanced binary tree

(76) Inventors: Kevin W. Burrows, North Bend, WA (US); Eric D. Schweickert, North Bend, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/764,011

(22) Filed: Jan. 17, 2001

(51) Int. Cl. G06F 17/00; G06F 7/00

(52) U.S. Cl. 707/100

(57) ABSTRACT

A computer implemented method for creating a balanced binary tree is provided, in which a list of elements is successively divided into left side and right side groupings. The median of each left side grouping is placed in the tree as a descendent node of the previous median until the list can no longer be divided. The method then involves walking back up the tree to find right-side medians and inserting them as right side descendent nodes into the binary tree. Whenever there is a choice between breaking down a left side grouping and breaking down a right side grouping, the left side grouping takes priority. The method may also be implemented so that right side groupings take priority.

### TECHNICAL FIELD

This invention relates generally to the creation of binary trees, and, more particularly, to the creation of balanced binary trees.

### BACKGROUND OF TILE INVENTION

A binary tree is a data structure having a series of linked nodes arranged in a tree-like pattern. The top node is often referred to as the “root.” Each node in the tree has a least one and as many as two pointers to child nodes. A “balanced” binary tree is generally symmetrical from left to right and has the same or nearly the same number of elements on the left and right sides. Binary trees are used in many types of computer programs. For example, in database programs, binary trees are used to facilitate searching for database records. Each node might represent a range of index numbers and, instead of sorting through the index numbers from start to finish, which can be time consuming, the database program can simply walk through the tree along nodes that are in the correct range until it reaches a node that points to the sought-after record.

Binary trees work best when they are balanced. Once an unbalanced binary tree has been created, it is time consuming and memory intensive to rebalance the tree. Data that is to be assembled into a tree can be pre-processed to insure that, once the tree is built, that it is balanced. This is also time consuming, however. Thus it can be seen that there is a need for an improved method for creating a balanced binary tree.

### SUMMARY OF THE INVENTION

In accordance with this need, a computer implemented method for creating a balanced binary tree is provided, in which a list of elements is successively divided into left side and right side groupings. The median of each left side grouping is placed in the tree as a descendent node of the previous median until the list can no longer be divided. The method then involves walking back up the tree to find right-side medians and inserting them as right side descendent nodes into the binary tree. Whenever there is a choice between breaking down a left side grouping and breaking down a right side grouping, the left side grouping takes priority. The method may also be implemented so that right side groupings take priority.

Additional features and advantages of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is an example of a computer network;

FIG. 2 is an example of a computer;

FIGS. 3-4 shows the general setup of an embodiment of the invention;

FIG. 5 is a flowchart showing an example of steps that may be followed to create a balanced binary tree according to an embodiment of the invention;

FIGS. 6-11 show how an embodiment of the invention progresses through a list to create a binary tree;

FIG. 12 is a flowchart showing an example of a recursive implementation of an embodiment of the invention; and,

FIG. 13 shows the general setup of a more specific embodiment of the invention.

### DETAILED DESCRIPTION OF THE INVENTION

The invention is generally directed a method for balancing a binary tree in which a computer or equivalent device receives a sorted linked list as input. The computer then builds the left side child nodes of the binary tree by successively subdividing the list and finding the median element of each subdivision. Each successive median is then linked to the previous median as a left child node in the binary tree. The computer then repeats this procedure for the right side subdivisions, working its way back up the tree to build the right side child nodes. Of course, it is understood that the procedure may be modified so that the right-side child node are built first and so that priority is given to the right side subdivisions.

Although it is not required, the invention may be implemented by computer-executable instructions, such as program modules, that are executed by a computer. Generally, program modules include routines, programs, objects, components, data structures and the like that perform particular tasks or implement particular abstract data types. On many computers, modules execute within an address space of the computer's memory, which is typically defined as a “process.” The point of execution of the program instructions is often referred to as a “thread.” As is conventional, multiple threads of execution may exist for a single program in a process. Multiple processes may be executed on a single machine, with each process having one or more threads of execution. Thus, when multiple threads are discussed herein, it may mean multiple threads in a single process or multiple threads in different processes.

The invention may be implemented on a variety of types of computers, including personal computers (PCs), hand-held devices, multi-processor systems, microprocessor-based on programmable consumer electronics, network PCs, minicomputers, mainframe computers and the like. The invention may also be employed in distributed computing environments, where tasks are performed by remote processing devices that are linked through a communications network. In a distributed computing environment, modules may be located in both local and remote memory storage devices.

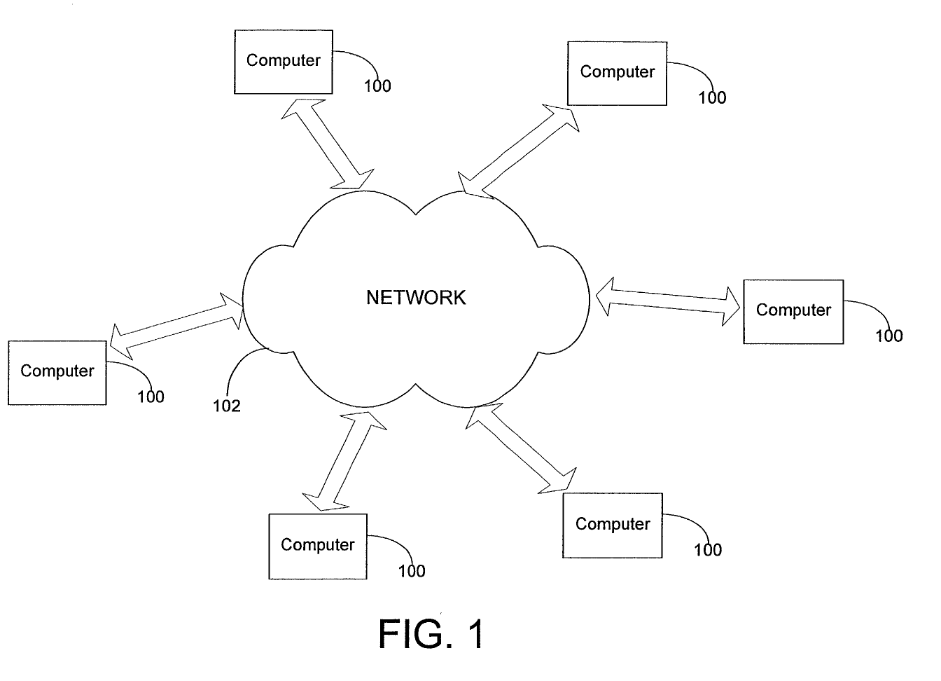

An example of a networked environment in which this system may be used will now be described with reference to FIG. 1. The example network 102 includes several computers 100 communicating with one another. The network 102 may include many well-known components, such as routers, gateways, hubs, etc. and may allow the computers 100 to communicate via wired and/or wireless media.

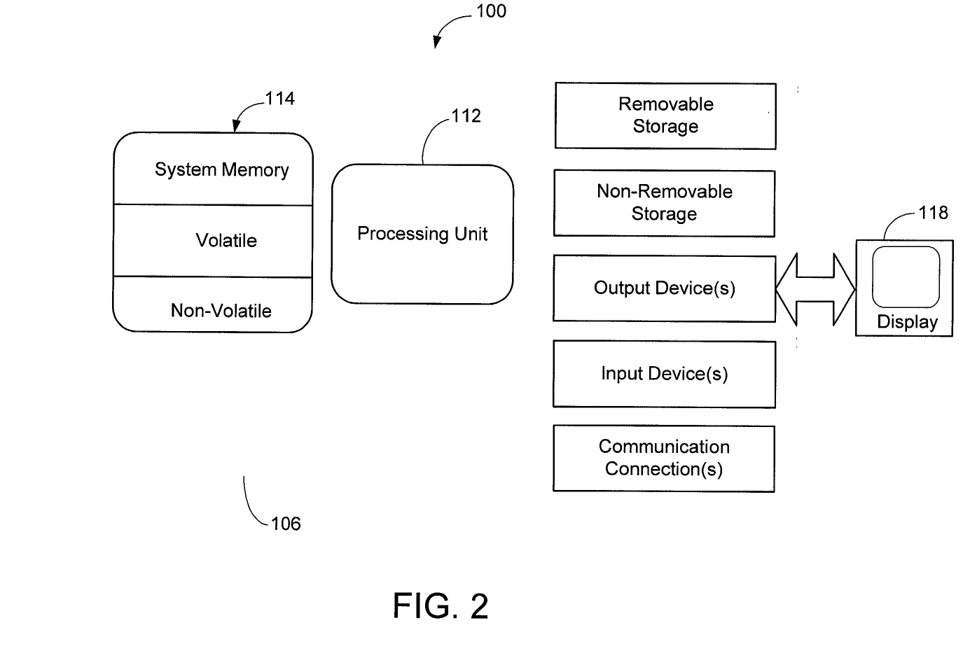

Referring to FIG. 2, an example of a computer on which the invention described herein may be implemented is shown. In its most basic configuration, the computer, generally labeled 100, typically includes at least one processing unit 112 and memory 114. Depending on the exact configuration and type of the computer, the memory 1 14 may be volatile (such as RAM), non-volatile (such as ROM or flash memory) or some combination of the two. This most basic configuration is illustrated in FIG. 2 by dashed line 106. The computer 100 may also have additional features/functionality. For example, computer 100 may include additional storage (removable and/or non-removable) including, but not limited to, magnetic or optical disks or tape. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the computer 100. Any such computer storage media may be part of computer 100.

Computer 100 may also contain communications connections that allow it to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not of limitation, communication media includes wired media such as a wired network or direct-wired connection, and wireless media such as acoustic, RF, infrared and other wireless media. The term computer-readable media as used herein includes both storage media and communication media.

Computer 100 may also have input devices such as a keyboard, mouse, pen, voice input device, touch input device, etc. Output devices such as a display 118, speakers, a printer, etc. may also be included. All these devices are well known in the art and need not be discussed at length here.

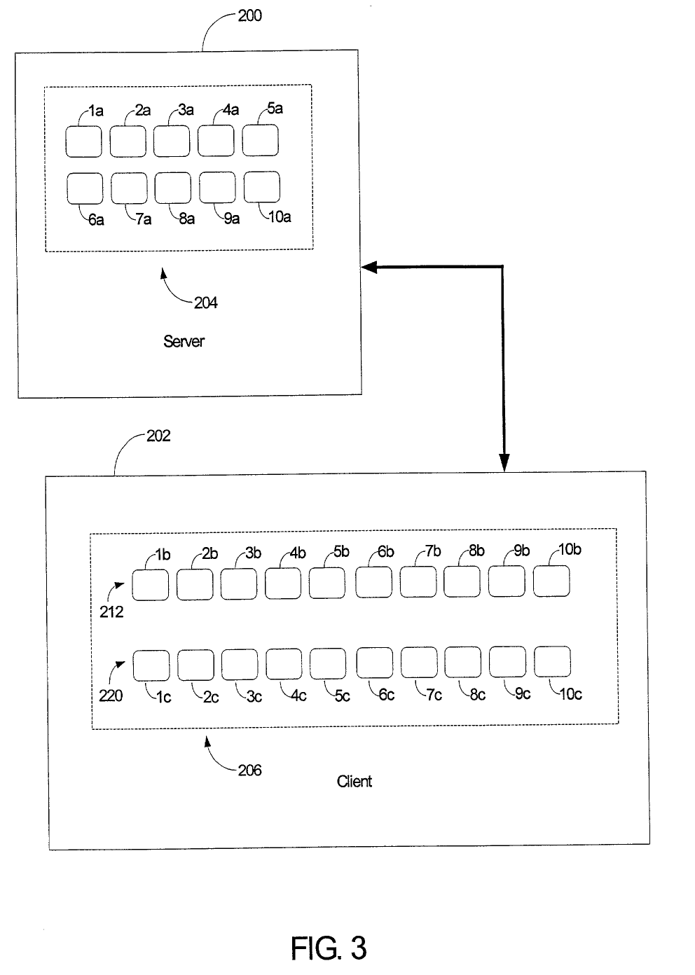

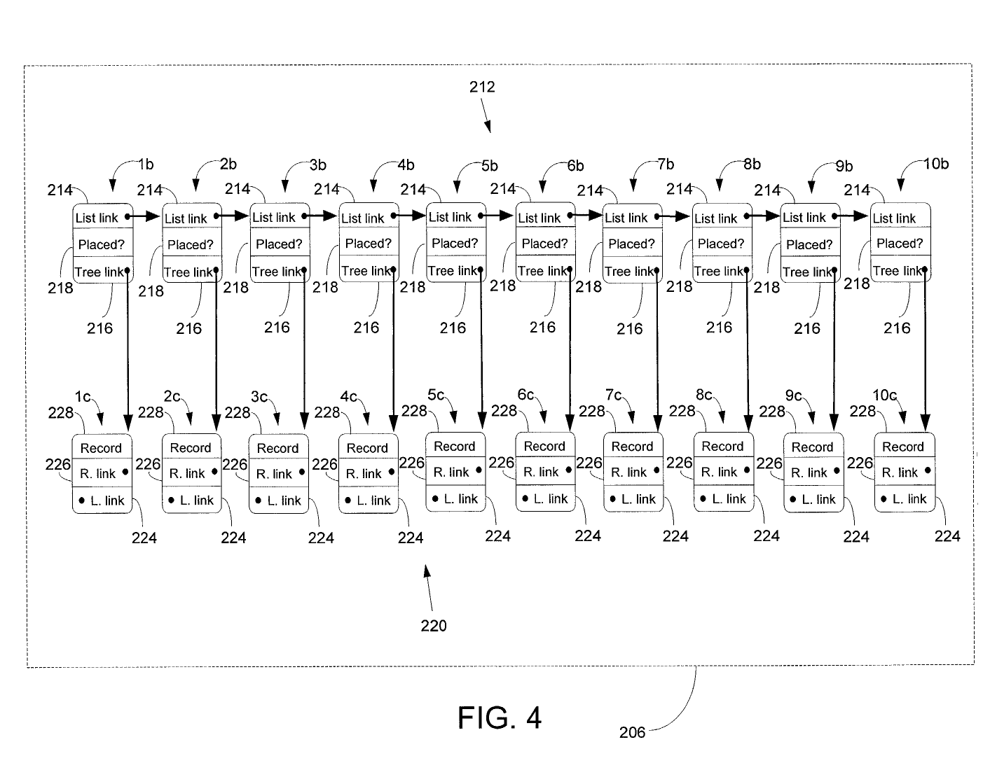

Referring to FIGS. 3 and 4, an embodiment of the invention will now be described. In this embodiment, it is assumed a server computer 200 (FIG. 3) is communicatively linked to a client computer 202. A set 204 of ten records (labeled 1a-10a) is stored on the server computer 200. It is understood that the number of records shown is an example, and that the invention may work for any number of records. Each record of the set 204 has a respective index value from 1 to 10. The records are initially unsorted. The client computer 202 retrieves the records and insertion-sorts them into a data structure 206 that is a combination of a linked list 212 and an unassembled binary tree 206. As shown more clearly in FIG. 4, the linked list 212 includes a series of objects 1b-10b. The unassembled tree 220 itself includes nodes 1c-10c that are eventually to be assembled. Each object 1b-10b of the list 212 represents one of the records 1a-10a of the set 204 (from FIG. 3). Each object 1b-10b includes a pointer 214 to the next object in the list, a pointer 216 to one of the nodes 1c-10c, and a Boolean flag 218, initially set to FALSE, to indicate whether the record represented by the object has been placed in its final location as a node in the assembled binary tree.

Each of the nodes 1c-10c of the unassembled tree 220 includes a left child pointer 224 that points to the node's left child, a right child pointer 226 that points to the node's right child, and a pointer 228 to the record itself. As can be seen from FIGS. 3 and 4, the linked list 212 acts as a wrapper around the nodes of the unassembled tree 220. The actual tree nodes, as well as the record data, are not contained within the list 212, but are simply pointed to by the list members. Other implementations are possible, however.

The computer 202 builds a balanced binary tree by taking the linked list 212, successively subdividing it into smaller and smaller groupings, and linking the median of each grouping with the median of the previous grouping. Specifically, the list is divided into a left side grouping and a right side grouping. The median of the list is then made the root of the binary tree. If the list has an even number of elements, then the left side median is used as the overall median. The median element of the left side grouping is then determined using the same procedure. This second median element will become the left child of the root. The left side grouping is then divided into a left and right side groupings, with the median becoming the left child of the second median element. This procedure continues until there are no more left side groupings in the list.

The procedure then involves traveling back up the partly assembled binary tree to pick up any right side groupings. The right side groupings themselves are repeatedly subdivided into further groupings, with each median element linked to the previous median element as its right child in the binary tree. Whenever there is a choice between processing a left side grouping and a right side grouping, the left side grouping takes precedence. However, it is understood that this is only a matter of convention, and that the entire procedure can be altered so that the right side elements are chosen as the medians (in cases of even numbered groupings) and so that the right side groupings are always processed first. Each time a node is placed within the partly assembled binary tree, the Boolean flag 222 of the corresponding element in the linked list 212 is set to TRUE. This prevents an element from being placed more than once in a tree.

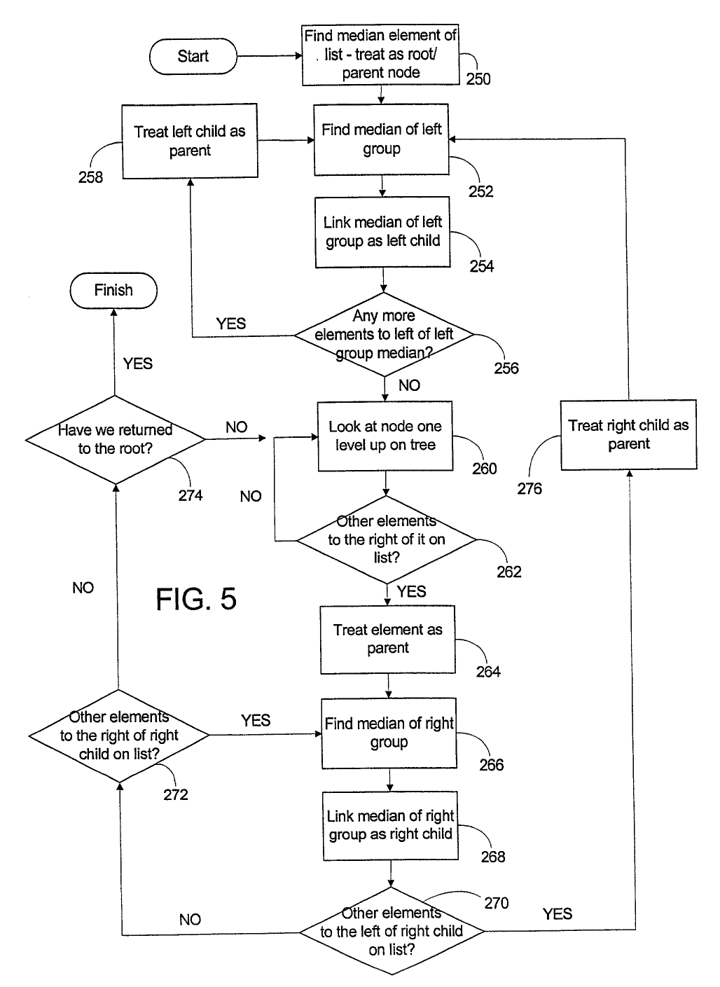

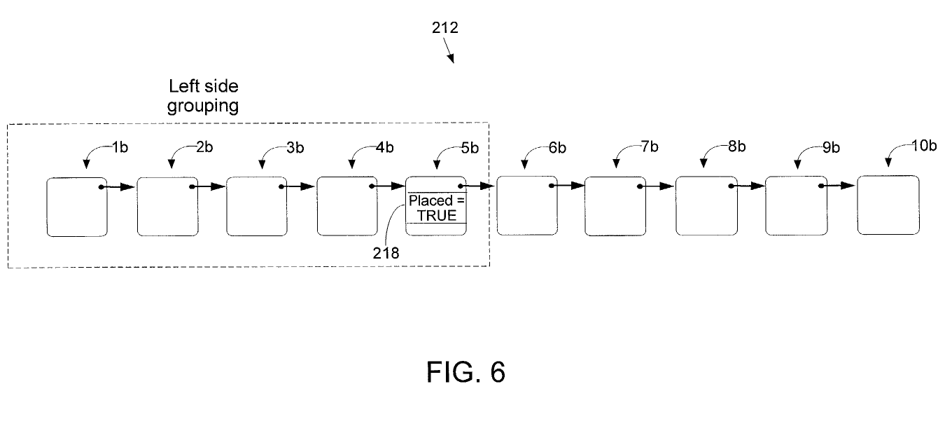

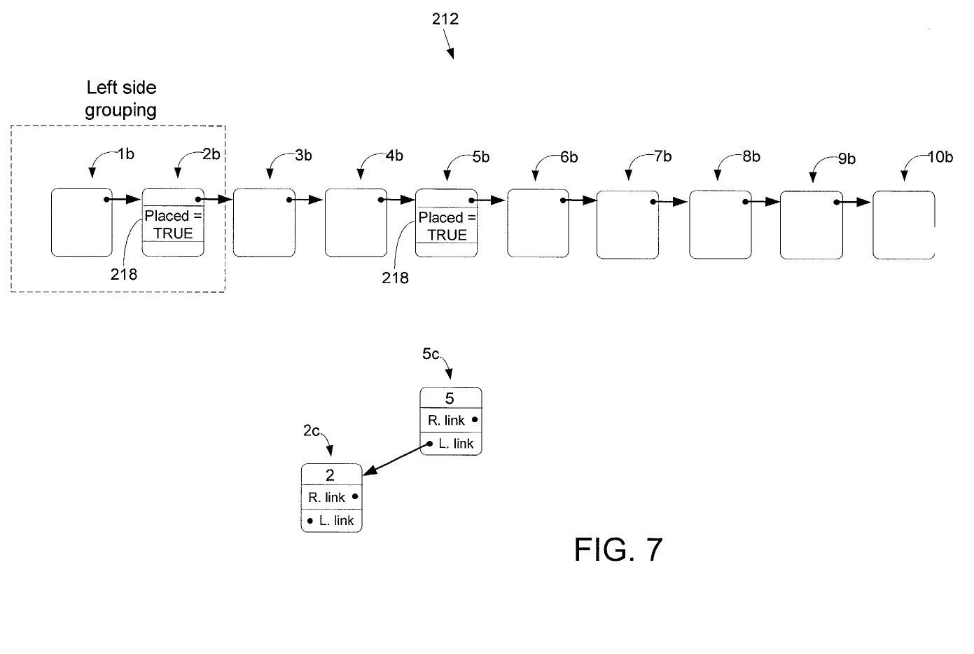

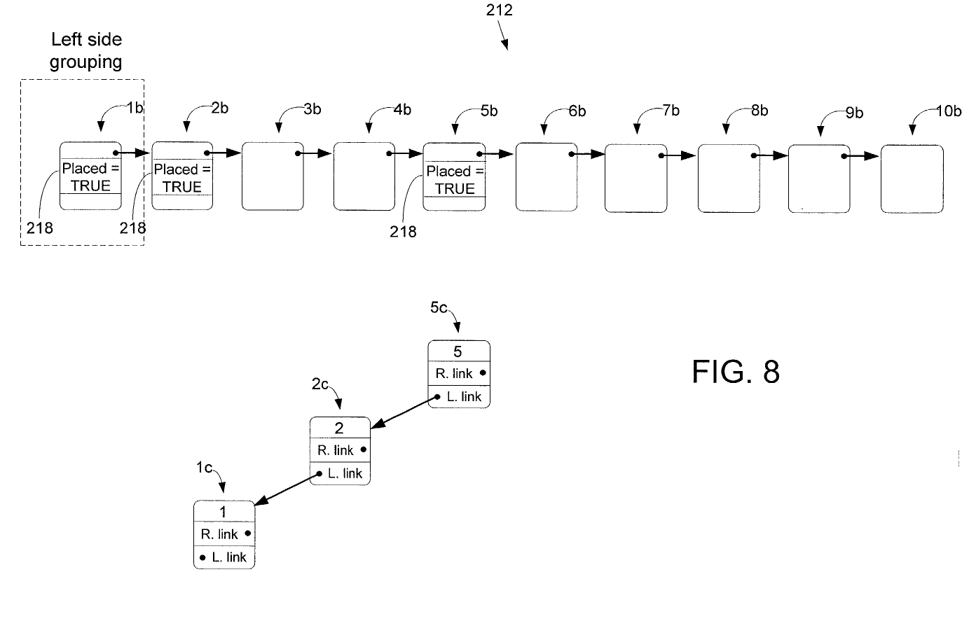

Referring to the flowchart of FIG. 5, with appropriate reference to FIGS. 6-11, an example of steps that may be followed by a computer to assemble a balanced binary tree will now be described. To help illustrate the steps, it will be assumed that the procedure is being performed using the setup of FIGS. 3 and 4, and appropriate reference will be made thereto. At step 250, the computer 202 (FIG. 3) determines which element of the list 212 (FIG. 4) is the median element. Since there are an even number of elements, the object 5b (representing record 5a of FIG. 3) is treated as the overall median. The node 5c is then made the root of the binary tree, and its Boolean flag is set to TRUE, as shown in FIG. 6. At step 252, the computer 202 determines which element is the median of the left side grouping. The left side grouping includes those elements of the linked list that are to the left of 5b—namely, elements 1b, 2b, 3b and 4b. Again, since there are an even number of elements in this grouping, the object 2b is used. The node 2c is then made the left child of the node 5c, and its Boolean flag is set to TRUE, as shown in FIG. 7. The flow then continues to step 256, at which the computer 202 determines whether there are any unplaced elements to the left of object 2b. In this case, object 1b remains as a left side grouping of object 2b. The flow then moves to step 258, at which the object 2b is now treated as a parent object for the next steps. Steps 252 through 256 are then repeated, during which the object 1b is treated as the median of the left side grouping and the node 1c is placed as the left child of node 2c, as shown in FIG. 8. The flow then moves to step 260, since there are no more elements to the left of object 1b.

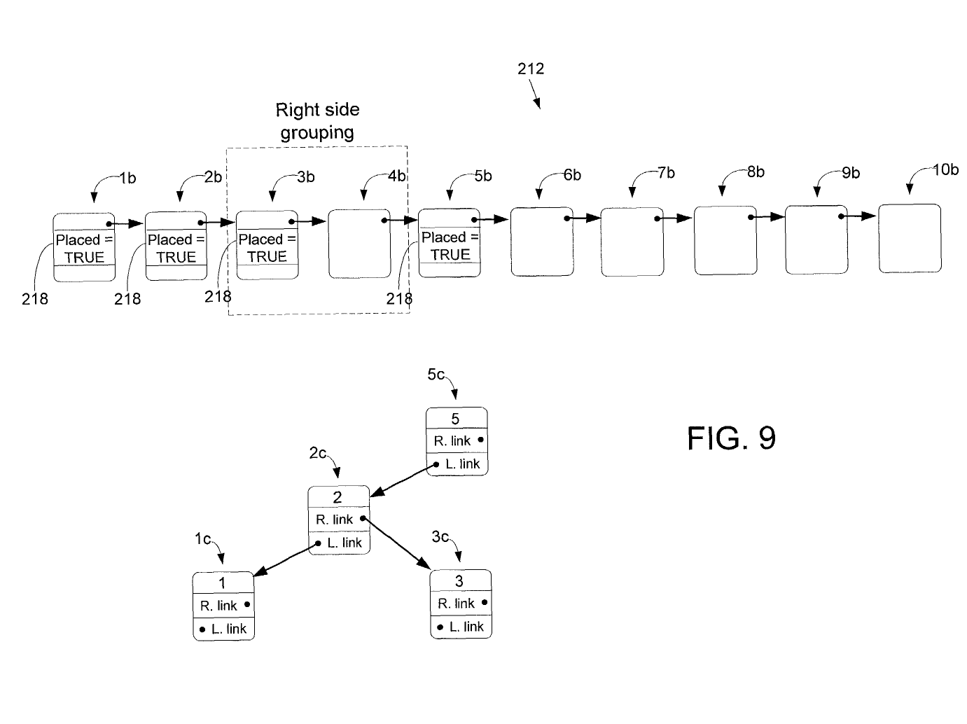

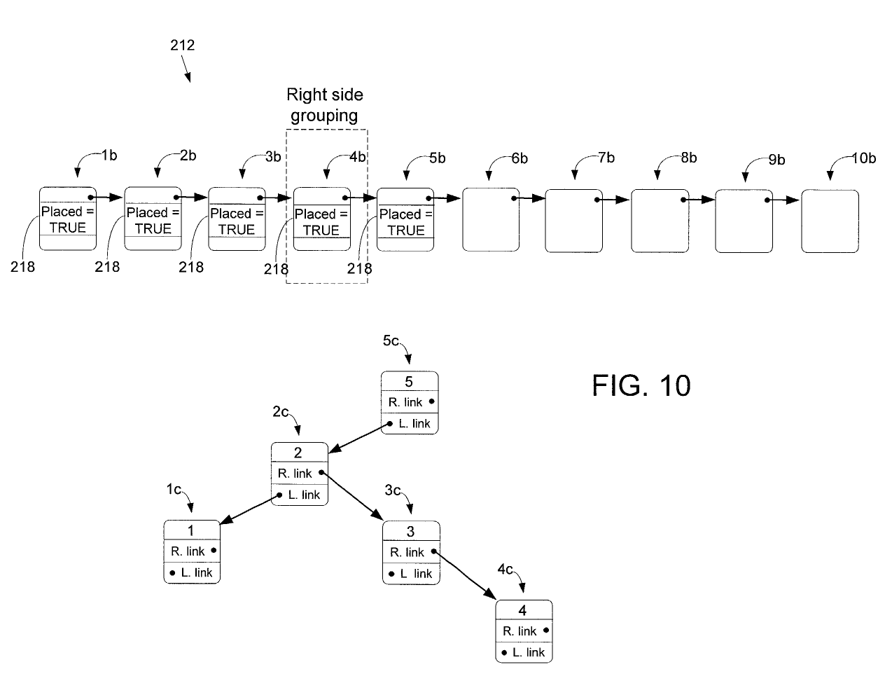

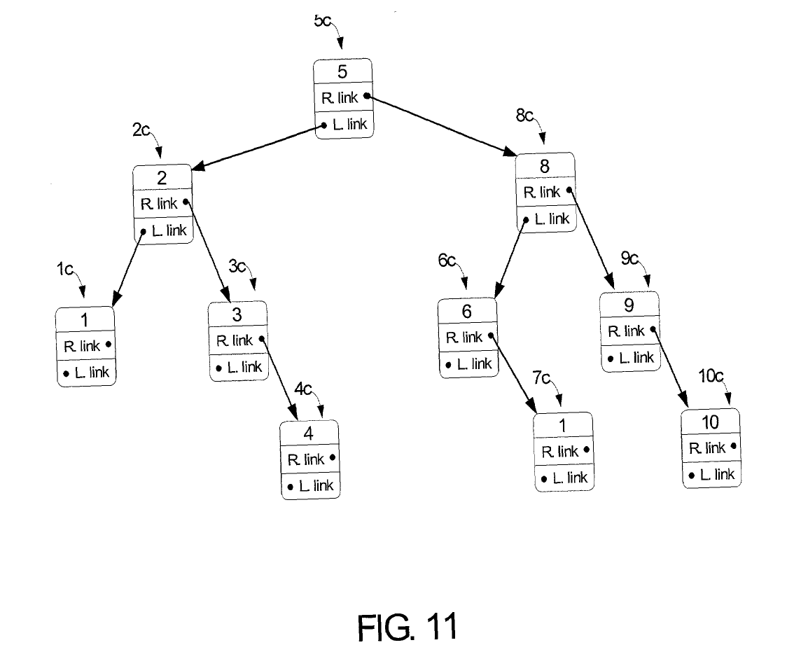

At step 260, the computer 202 moves back one level on the partially assembled binary tree to the previous node. At step 262, the computer checks to see if the element in the list 212 corresponding to the previous node has any elements to the right of it. In this case, the previous node was node 2c (FIG. 8), so the computer looks at object 2b in the list 212 and sees that 2b does, in fact, have elements to the right of it in its grouping. Specifically, objects 3b and 4b are to the right of object 2b in the left half of the list 212, with object 3b as the median of that small sub-grouping. The flow then continues to steps 264-268, in which the node 2c is treated as a parent node and node 3c as its right child (FIG. 9). The computer then determines whether object 3b has any unplaced elements to the left of it at step 270. Since there are none, the flow proceeds to step 272, at which the computer looks at the right side of object 3b, and sees that there is one unplaced element in the same sub-grouping as object 3b, namely object 4b. Steps 262 and 268 are repeated, and node 4c is placed as the right child of node 3c (FIG. 10). The steps of FIG. 5 are repeated until the computer has walked back up the binary tree to the root node, at which point it determines that the tree is complete. The computer 202 then deletes the list 212, leaving only the completed, balanced tree as shown in FIG. 11.

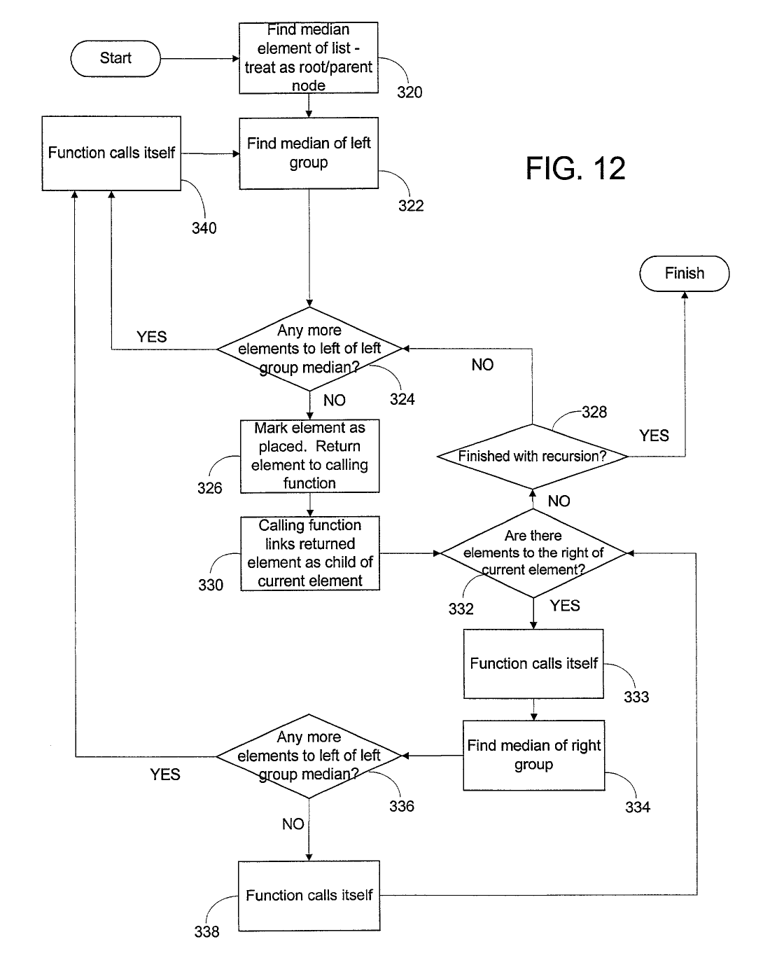

There are many ways in which the above-described procedure may be implemented as a computer program. In an embodiment of the invention, the procedure is implemented as a function that receives a pointer to the linked list 212 (FIG. 4) and a pointer to the unassembled binary tree 220. The function then recursively divides the linked list, passes the median to itself, divides again, etc., until it can divide the list no more. The function then starts filling in the bottommost node on the left side of the tree and walks its way back up. As it makes its way back up, it fills in the remaining nodes. Referring to the flowchart of FIG. 12, an example of how such a function may work will now be described.

The term “present median” will be used to refer to the median of that has been passed to the instance of the function being used in a step, while the term “returned median” will be used to refer to a median that has been returned by another instance of the function used in another step. At step 320, the function locates the median element of the list 212 (FIG. 4), and establishes the corresponding node as the root of the tree. At step 322, the function locates the median element of the left side group. At step 324, the function determines whether there are any more elements to the left of the present median. If there are, then the function calls itself again (step 340) and the new instance of the function moves back to step 322, using the elements to the left of the present median as the new left side grouping. If there are no more elements to the left side of the present median, then the flow proceeds to step 326, at which the function returns a pointer to the tree node corresponding to the present median to the instance of the function from which it was originally called, and the Boolean flag of the present median is set to TRUE. At step 330, the calling function links the tree node referenced by the returned median to the present median. The returned median is linked as either the left child or right child of the present median, depending on which side of the present median it is located in the linked list. At step 332, the function determines whether there are any elements to the right of the present median. If there are, the flow proceeds to step 333. If not, then the flow moves to step 328. If, at step 328, the chain of recursions is complete, then the procedure ends. Otherwise, it returns to step 324.

If, at step 332, the function determines that there are elements to the right of the present median, then the flow proceeds to step 333, at which the function calls itself and passes the present median to the new instance. In the new instance of the function (step 334), the function locates the median of the right side grouping of the present median. The flow then moves to step 336. At step 336, the function determines whether there are any elements to the left of the present element. If there are, then the flow moves to step 340. If not, then the flow moves to step 338, at which the function calls itself and passes the present median to the new instance.

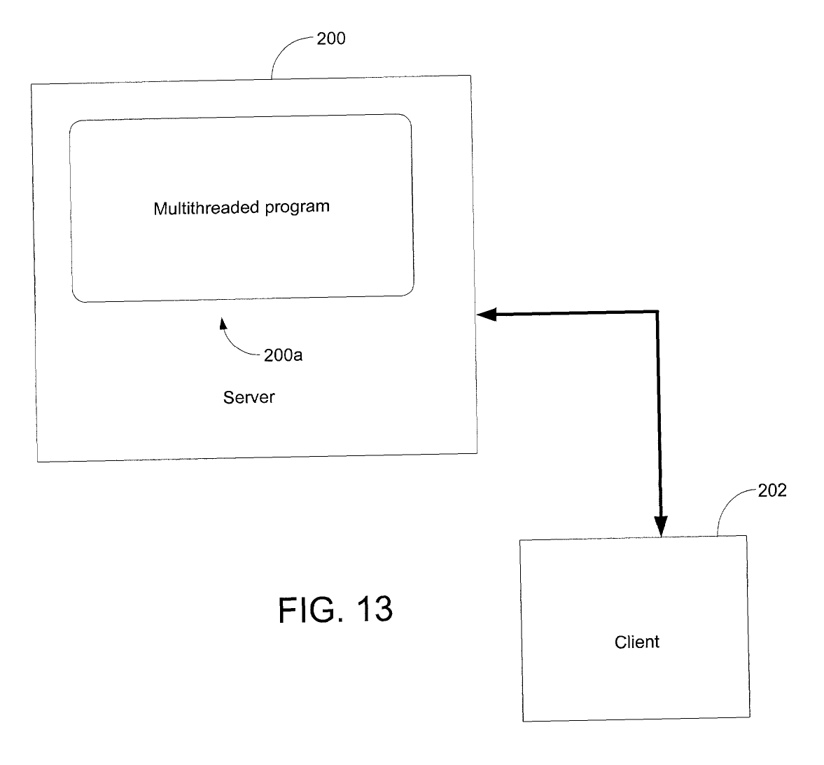

Referring to FIG. 13, a more specific embodiment of the invention will now be described using elements introduced in FIG. 3. In this embodiment, the server computer 200 executes a multithreaded program 200a whose performance is being monitored at the client computer 202. Specifically, the program 200a is running several threads of execution through various code modules. Each time it passes through a different code module, it logs the event in a log 350. Once the program 200a has completed a series of test runs, the client computer 202 retrieves the log data and organizes it into a binary tree according to one or more of the procedures described above.

It can thus be seen that a new a useful method and system for creating a balanced binary tree has been provided. In view of the many possible embodiments to which the principles of this invention may be applied, it should be recognized that the embodiments described herein with respect to the drawing figures is meant to be illustrative only and should not be taken as limiting the scope of invention. For example, those of skill in the art will recognize that the elements of the illustrated embodiments shown in software may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

We claim:

1. A method for creating a binary tree from a list of elements, wherein the list includes left side groupings and right side groupings, the method comprising: inserting left side descendent nodes into the binary tree by successively finding the median of each left side grouping and linking each found median to the previous median; inserting right side descendent nodes into the binary tree by successively finding the median of each right side grouping and linking each found median to the previous median; and processing left side groupings in preference to right side groupings.

2. A computer-readable medium having stored thereon computer-executable instructions for performing the method of claim 1.

3. The method of claim 1, wherein each element in the list includes a pointer to a corresponding node of a plurality of nodes in a partially assembled binary tree, wherein each node has a left child pointer, and wherein inserting the left side nodes further comprises assigning a value to the left side pointer of at least one of the nodes.

4. The method of claim 1, wherein each element in the list includes a pointer to a corresponding node of a plurality of nodes in a partially assembled binary tree, wherein each node has a right child pointer, and wherein inserting the right side nodes further comprises assigning a value to the right side pointer of at least one of the nodes.

5. The method of claim 1, wherein inserting the left side descendent nodes comprises inserted the left side descendent nodes into a partially assembled version of the binary tree, wherein inserting the right side descendent nodes comprises inserted the right side descendent nodes into the partially assembled version of the binary tree, and wherein the list is a linked list that acts as a wrapper around the partially assembled version of the binary tree.

6. The method of claim 1, wherein the elements of the list include logged events.

7. The method of claim 1, wherein the elements of the list include data representing the number of times one or more threads of execution have passed through one or more code modules.

8. The method of claim 1, wherein the inserted right and left descendant nodes include data representing the number of times one or more threads of execution have passed through one or more code modules.

9. The method of claim 1, wherein the inserted right and left descendant nodes include one or more pointers to data representing the number of times one or more threads of execution have passed through one or more code modules.

10. The method of claim 1, wherein the list is an ordered linked list.

11. A method for creating a binary tree from a list of elements, wherein the list includes left side groupings and right side groupings, the method comprising:
(a) successively subdividing the left side groupings of the list and linking each successive median element with the previous median element, thereby creating left side descendent nodes in the binary tree;
(b) once each left side grouping has been exhausted as a result of step (a), stepping back up the tree through each successive ancestor node until reaching an element having right side groupings in the list, and, upon reaching an element having a right side grouping in the list, proceeding to step (c);
(c) subdividing the right side groupings and linking the median element of the right side grouping with the element reached in step (b), thereby creating a right side descendent of the tree;
(d) if the right side descendent of step (c) has a left side grouping in the list, repeating step (a) for the left side grouping; and
(e) if the right side descendent of step (c) has no left side groupings, but has a right side grouping, repeating step (c) for the right side grouping.

12. A computer-readable medium having stored thereon computer-executable instructions for performing the method of claim 11.

13. A method for creating a binary tree from a list of elements, wherein the list includes left side groupings and right side groupings, the method comprising:
(a) determining if there are elements to the left of a parent element;
(b) if there are no elements to the left of the parent element, proceeding to step (f);
(c) for the elements that are to the left of the parent element, finding a median element;
(d) linking the median element of step (c) to the parent element so that the median element is the child of the parent element;
(e) repeating steps (b) and (c), wherein the child element of step (d) is now treated as the parent element in steps (b) and (c);
(f) locating the next element up on the tree that has elements to the right of it and treating the element as a parent element in step (g);
(g) finding the median element of the elements to the right of the parent element from step (f);
(h) linking the median element of step (g) to the parent element of step (g), wherein the median element is the child of the parent; and
(i) repeating steps (b) through (e), wherein the child element of step (h) is treated as the parent element in step (b).

14. A computer-readable medium having stored thereon computer-executable instructions for performing the method of claim 13.

15. A method for creating a binary tree from a list of elements, wherein the list includes left side groupings and right side groupings, the method comprising: inserting right side descendent nodes into the binary tree by successively finding the median of each right side grouping and linking each found median to the previous median; inserting left side descendent nodes into the binary tree by successively finding the median of each left side grouping and linking each found median to the previous median; and processing right side groupings in preference to left side groupings.

16. A computer-readable medium having stored thereon computer-executable instructions for performing the method of claim 15.

17. The method of claim 15, wherein each element in the list includes a pointer to a corresponding node of a plurality of nodes in a partially assembled binary tree, wherein each node has a right child pointer, and wherein inserting the right side nodes further comprises assigning a value to the right side pointer of at least one of the nodes.

18. The method of claim 15, wherein each element in the list includes a pointer to a corresponding node of a plurality of nodes in a partially assembled binary tree, wherein each node has a left child pointer, and wherein inserting the left side nodes further comprises assigning a value to the left side pointer of at least one of the nodes.

19. The method of claim 15, wherein inserting the right side descendent nodes comprises inserted the right side descendent nodes into a partially assembled version of the binary tree, wherein inserting the left side descendent nodes comprises inserted the left side descendent nodes into the partially assembled version of the binary tree, and wherein the list is a linked list that acts as a wrapper around the partially assembled version of the binary tree.

20. The method of claim 15, wherein the elements of the list include logged events.

21. The method of claim 15, wherein the elements of the list include data representing the number of times one or more threads of execution have passed through one or more code modules.

22. The method of claim 15, wherein the inserted right and left descendant nodes include data representing the number of times one or more threads of execution have passed through one or more code modules.

23. The method of claim 15, wherein the inserted right and left descendant nodes include one or more pointers to data representing the number of times one or more threads of execution have passed through one or more code modules.

24. The method of claim 15, wherein the list is an ordered linked list.

25. A method for creating a binary tree from a list of elements, wherein the list includes right side groupings and left side groupings, the method comprising:
(a) successively subdividing the right side groupings of the list and linking each successive median element with the previous median element, thereby creating right side descendent nodes in the binary tree;
(b) once each right side grouping has been exhausted as a result of step (a), stepping back up the tree through each successive ancestor node until reaching an element having left side groupings in the list, and, upon reaching an element having a left side grouping in the list, proceeding to step (c);
(c) subdividing the left side groupings and linking the median element of the left side grouping with the element reached in step (b), thereby creating a left side descendent of the tree;
(d) if the left side descendent of step (c) has a right side grouping in the list, repeating step (a) for the right side grouping; and
(e) if the left side descendent of step (c) has no right side groupings, but has a left side grouping, repeating step (c) for the left side grouping.

26. A computer-readable medium having stored thereon computer-executable instructions for performing the method of claim 25.

27. A method for creating a binary tree from a list of elements, wherein the list includes right side groupings and left side groupings, the method comprising:
(a) determining if there are elements to the right of a parent element;
(b) if there are no elements to the right of the parent element, proceeding to step (f);
(c) for the elements that are to the right of the parent element, finding a median element;
(d) linking the median element of step (c) to the parent element so that the median element is the child of the parent element;
(e) repeating steps (b) and (c), wherein the child element of step (d) is now treated as the parent element in steps (b) and (c);
(f) locating the next element up on the tree that has elements to the left of it and treating the element as a parent element in step (g);
(g) finding the median element of the elements to the left of the parent element from step (f);
(h) linking the median element of step (g) to the parent element of step (g), wherein the median element is the child of the parent; and
(i) repeating steps (b) through (e), wherein the child element of step (h) is treated as the parent element in step (b).

28. A computer-readable medium having stored thereon computer-executable instructions for performing the method of claim 27.
